(19) United States
(12) Patent Application Publication
(10) Pub. No.: US 2026/0104616 A1
(43) Pub. Date: Apr. 16, 2026

(54) ELECTROCHEMICAL DEVICES AND METHODS OF FORMING SAME

(71) Applicant: SAGE ELECTROCHROMICS, INC., Faribault, MN (US)

(72) Inventors: Yan WANG, Lakeville, MN (US); Robert Newcomb, Minneapolis, MN (US); Théo Nathan Ferdinand Chevallier, Minneapolis, MN (US); Ryan T. Allen, Minneapolis, MN (US)

(21) Appl. No.: 19/351,472

(22) Filed: Oct. 7, 2025

Related U.S. Application Data
(60) Provisional application No. 63/706,380, filed on Oct. 11, 2024.

(51) Int. Cl. G02F 1/1523; G02F 1/155

(52) U.S. Cl. CPC G02F 1/1525; G02F 1/155; G02F 2001/1555

(57) ABSTRACT

An electrochemical device is disclosed. The electrochemical device can include a first transparent conductive layer, a second transparent conductive layer, an electrochromic layer between the first transparent conductive layer and the second transparent conductive layer, a counter electrode layer having a thickness of greater than 300 nm and between the first transparent conductive layer and the second transparent conductive layer, a switching speed parameter of not greater than 0.68 s/mm at 23° C., and a color of less than 3b* in a tint state.

### CROSS-REFERENCE TO RELATED APPLICATION(S)

This application claims priority under 35 U.S.C. § 119(e) to U.S. Provisional Application No. 63/706,380, entitled “ELECTROCHEMICAL DEVICES AND METHODS OF FORMING SAME,” by Yan WANG et al., filed Oct. 11, 2024, which is incorporated herein by reference in its entirety.

### FIELD OF THE DISCLOSURE

The present disclosure is related to electrochemical devices and methods of forming the same.

### BACKGROUND

An electrochemical device can include an electrochromic stack where transparent conductive layers are used to provide electrical connections for the operation of the stack. Electrochromic (EC) devices employ materials capable of reversibly altering their optical properties following electrochemical oxidation and reduction in response to an applied potential. The optical modulation is the result of the simultaneous insertion and extraction of electrons and charge compensating ions in the electrochemical material lattice.

EC devices have a composite structure through which the transmittance of light can be modulated. An electrochromic device typically includes a first transparent conductive layer which serves to apply an electrical potential to the electrochromic device, an electrochromic electrode layer which produces a change in absorption or reflection upon oxidation or reduction, an ion conductor layer which functionally replaces an electrolyte, allowing the passage of ions while blocking electronic current; a counter electrode layer which serves as a storage layer for ions when the device is in the bleached or clear state; and a second transparent conductive layers. However, electrochromic devices have the drawback of having a residual color in transmission when in the clear state. To mitigate the yellow-blue hue, typically an additional layer is added to compliment and neutralize the hue. This additional layer often leads to losses in light transmission and slower switching speeds between dark and clear states.

As such, further improvements are sought in the context of electrochromic devices.

### BRIEF DESCRIPTION OF THE DRAWINGS

FIG. 1 is a schematic cross-section of an electrochromic device with an improved film structure, in accordance with one embodiment of the present disclosure.

FIG. 2 is a flow chart depicting a process for forming an electrochemical device, in accordance with one embodiment of the current disclosure.

FIGS. 3A-3E are a schematic cross-section of the manufacturing of an electrochromic device with an improved film structure, in accordance with embodiments of the present disclosure.

FIG. 4 is a schematic of an insulated glazing unit containing an electrochromic device with an improved film structure, in accordance with one embodiment of the present disclosure.

FIG. 5 is a schematic graph of the transmitted color as the electrochromic device switches from a clear state (high b*) to a tint state (low negative b*).

FIG. 6A is TEM diffraction of the crystallinity of an electrochromic layer deposited at an average temperature of about 290° C.

FIG. 6B is TEM diffraction of the crystallinity of an electrochromic layer deposited at an average temperature of less than 280° C.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific embodiments and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Patterned features, which include bus bars, holes, holes, etc., can have a width, a depth or a thickness, and a length, wherein the length is greater than the width and the depth or thickness. As used in this specification, a diameter is a width for a circle, and a minor axis is a width for an ellipse.

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated.

“Tinted transmission parameter” is a measurement the percentage of variable light transmission device through an insulated glass unit stabilized at a tinted state measured by a camera/backlight apparatus. The camera and backlight are set up in the following steps. The camera gain and exposure are adjusted such a plain backlight has the brightest pixels with 22% of full scale. The camera is set with no corrections of any kind. The camera is focused on the backlight. White balance numbers from the camera drivers are recorded. The camera records an image with the backlight off as the “dark reference.” The dark reference defines 0% T for each pixel. The camera records an image with the backlight on, exposed, and stable as the “bright reference.” The bright reference defines 100% T for each pixel. The camera is color calibrated in the following steps. 1. Perform dark and bright reference as given above. 2. Use 12 different color standards to calibrate each tester. Each color standard consists of two 20″×20″ colored films purchased from Gam Products, Inc. The chart below gives the specific color and product number for the colored sheets. The two films are placed in a metal frame. Each of the 12 standards are first measured in the equipment HunterLab Colorquest XE, calibrated according to the manufacturer's standards, and recording data using the Universal software—obtaining the values L*, a*, b*. The 12 color standard films are then placed on the (exposed, stable) backlight in the orientation noted in the chart. All other light is blacked out. The area of the image with the color standard is selected in the software and the RGB colors recorded by the camera are noted as in the example below.

### Standards

| ←Toward Back Light | | R | G | B | Weight |
|---|---|---|---|---|---|
| Tan (435) | Clear | 0.91 | 0.826 | 0.713 | 1 |
| Tan (435) | Tan (435) | 0.892 | 0.743 | 0.574 | 9 |
| 0.15 ND | New Green (520) | 0.559 | 0.577 | 0.41 | 9 |
| 0.3 ND | Blue (785) | 0.222 | 0.357 | 0.486 | 1 |
| 1.2 ND | Clear | 0.07 | 0.058 | 0.086 | 1 |
| 1.2 ND | Blue (785) | 0.031 | 0.047 | 0.083 | 5 |
| 1.2 ND | 0.3 ND | 0.41 | 0.034 | 0.053 | 1 |
| New Green (520) | Yellow (440) | 0.818 | 0.842 | 0.423 | 1 |
| Old Green (540) | Clear | 0.89 | 0.911 | 0.788 | 1 |
| Yellow (440) | Clear | 0.912 | 0.878 | 0.663 | 3 |
| Yellow (440) | Old Green (540) | 0.87 | 0.849 | 0.575 | 1 |
| Yellow (440) | Yellow (440) | 0.894 | 0.835 | 0.48 | 5 |

Using L*a*b* color coordinates of standards, find optimum 3×3 matrix to multiply by the camera's measured [R G B] vector to convert it to an accurate [L* a* b*] vector. Start with a 3×3 matrix, [(0.3, 0.3, 0.3) (0.3, 0.3, 0.3) (0.3, 0.3, 0.3)] and multiply this by the measured [R G B] vector measured for each standard. This gives an initial calculated XYZ vector. Convert XYZ to Calculated L*a*b* by using the formulas:

$${L}^{*} = 116 f ( \frac{Y}{{Y}_{n}} ) - 16$$

$${a}^{*} = 500 ( f ( \frac{X}{{X}_{n}} ) - f ( \frac{Y}{{Y}_{n}} ) )$$

$${b}^{*} = 200 ( f ( \frac{Y}{{Y}_{n}} ) - f ( \frac{Z}{{Z}_{n}} ) )$$

$$Where f ( t ) = t \hat{} ( 1 / 3 )$$

$$Where Xn = 94.81 \; 10 , Yn = 1 \; 00 , Zn = 107.3 \; 04 for the selected illuminant D 65 CIE 1964 ( 10 deg )$$

Subtract the calculated L*a*b* values from the measured L*a*b* values from Hunterlab to get the delta, then square the delta to get the error in camera measurement for each calculated value L*a*b* for each standard. For each standard: Sum the squared deltas, and multiply them by the weighting value and name them E1, E2 . . . . E12. Take the square root of the sum of E1, E2 . . . . E12 to calculate Overall Error. Use the Solver function in Excel to solve the matrix such that the Overall Error is minimized. Multiplying measured R G B values for each standard will give you the most accurate calculated L*a*b* values. Enter the matrix into the software so that the matrix multiplies the measured RGB values. The software will then use this matrix for all future measurements to convert RGB to XYZ, and then to L*a*b* values. After doing this color calibration, to convert L* to % T: Take three neutral density (ND) filter calibration standards on glass, (2.2 mm thick glass, 225×662 mm rectangular area covered with neutral density filter with the following % T: 67% T, 45% T, 10% T) and measure HunterLab % T values. Put them on the backlight and cover up all other light. Take an image of the neutral density filters using the camera and record the L*a*b* values measured by the camera (corrected by the matrix as above). The software will compute % T from the equation: % T/100=[(L*−16)/116]\hat{ }3. To match the measured camera % T measurement with the actual Hunterlab % T measurement for the 3 ND filters: Start with 1:1 Hunterlab % T/camera % T ratio, and adjust the multiplier to 1:1.01, 1:1.02, etc. until the difference between each calculated % T value for the ND filters from the camera is within 0.5 percentage points of the ND filter calibration standards'% T Hunterlab measurement. Enter the multiplier into the software. From this point on, the software will adjust the measured RGB to an accurate L*a*b* and % T measurement for EACH pixel in the image. Each pixel will be assigned a0%-100% % T value by calculating (on a pixel-by-pixel basis) the following: [current reading−dark reference]/[bright reference−dark reference].

“Switching speed parameter” is a measurement of time in seconds/mm from the time 3V is applied to an electrochemical device to reach the calculated average of UT % T=5% visible light transmission from a bleached state (−2V) in a dark room with a backlight measured by a RGB camera. The camera and backlight are set up according the procedure described above with respect to the tinted transmission parameter. After the color calibration is completed, the average UT % T is calculated by first calculating the % T for each pixel of the electrochemical device and then calculating the average % T of all the pixels in the electrochemical device collectively.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

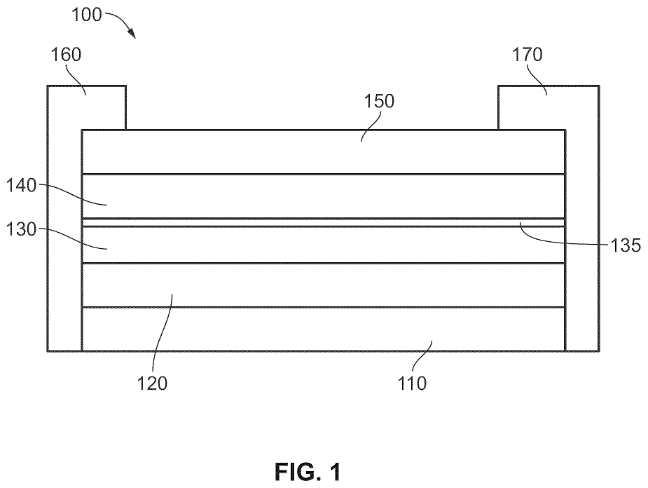

In accordance with the present disclosure, FIG. 1 illustrates a cross-section view of a partially fabricated electrochemical device 100 having an improved film structure. For purposes of illustrative clarity, the electrochemical device 100 is a variable transmission device. In one embodiment, the electrochemical device 100 can be an electrochromic device. In another embodiment, the electrochemical device 100 can be a thin-film battery. However, it will be recognized that the present disclosure is similarly applicable to other types of scribed electroactive devices, electrochemical devices, as well as other electrochromic devices with different stacks or film structures (e.g., additional layers). With regard to the electrochemical device 100 of FIG. 1, the device 100 may include a substrate 110, a first transparent conductor layer 120, a cathodic electrochemical layer 130, an anodic electrochemical layer 140, an ion conducting layer 160, and a second transparent conductor layer 150.

In one embodiment, the substrate 110 can include a glass substrate, a sapphire substrate, an aluminum oxynitride substrate, or a spinel substrate. In another embodiment, the substrate 210 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 110 may or may not be flexible. In a particular embodiment, the substrate 110 can be float glass or a borosilicate glass and have a thickness in a range of 0.5 mm to 12 mm thick. The substrate 110 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm. In another particular embodiment, the substrate 210 can include ultra-thin glass that is a mineral glass having a thickness in a range of 50 microns to 300 microns. In a particular embodiment, the substrate 110 may be used for many different electrochemical devices being formed and may referred to as a motherboard.

Transparent conductive layers 120 and 150 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 120 and 150 can include gold, silver, copper, nickel, aluminum, or any combination thereof. The transparent conductive layers 120 and 150 can include indium oxide, indium tin oxide, doped indium oxide, tin oxide, doped tin oxide, zinc oxide, doped zinc oxide, ruthenium oxide, doped ruthenium oxide and any combination thereof. The transparent conductive layers 120 and 150 can have the same or different compositions. The transparent conductive layers 120 and 150 can have a thickness between 10 nm and 600 nm. In one embodiment, the transparent conductive layers 120 and 150 can have a thickness between 200 nm and 500 nm. In one embodiment, the transparent conductive layers 220 and 250 can have a thickness between 320 nm and 460 nm. In one embodiment the first transparent conductive layer 120 can have a thickness between 10 nm and 600 nm. In one embodiment, the second transparent conductive layer 150 can have a thickness between 80 nm and 600 nm.

The layers 130 and 140 can be electrode layers, wherein one of the layers may be an electrochromic layer, and the other of the layers may be an counter electrode layer (also referred to as an anodic electrochemical layer). In one embodiment, the electrochromic layer 130 can include an inorganic metal oxide material, such as WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), or any combination thereof and can have a thickness in a range of 40 nm to 600 nm. In one embodiment, the electrochromic layer 130 can have a thickness between 100 nm to 400 nm. In one embodiment, the electrochromic layer 130 can have a thickness between 350 nm to 390 nm. The electrochromic layer 130 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The counter electrode layer 140 can include any of the materials listed with respect to the electrochromic layer 130 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the counter electrode layer 140 can have a thickness between 150 nm to 300 nm. In one embodiment, the counter electrode layer 140 can have a thickness between 250 nm to 290 nm. In some embodiments, lithium may be inserted into at least one of the first electrode 130 or second electrode 140.

In one embodiment, the device 100 may include an ion conducting layer 235 between the two electrode layers 130 and 140. The ion conducting layer 235 may have a thickness of no greater than 20 nm, such as no greater than 10 nm, no greater than 9 nm, no greater than 8 nm, no greater than 7 nm, or no greater than 6 nm. The ion conducting layer 235 may include lithium, sodium, oxidized lithium, Li₂WO₄, tungsten, nickel, lithium carbonate, lithium hydroxide, lithium peroxide, or combinations thereof.

In another embodiment, the device 100 may include a plurality of layers between the substrate 110 and the first transparent conductive layer 120. In one embodiment, an antireflection layer is between the substrate 110 and the first transparent conductive layer 120. The antireflection layer can include SiO₂, NbO₂, and can be a thickness between 20 nm to 100 nm. The device 100 may include at least two bus bars. In the embodiment of FIG. 1, two bus bars 160, 170 are shown. The bus bar 160 can be electrically connected to the first transparent conductive layer 120 and the bus bar 170 can be electrically connected to the second transparent conductive layer 150.

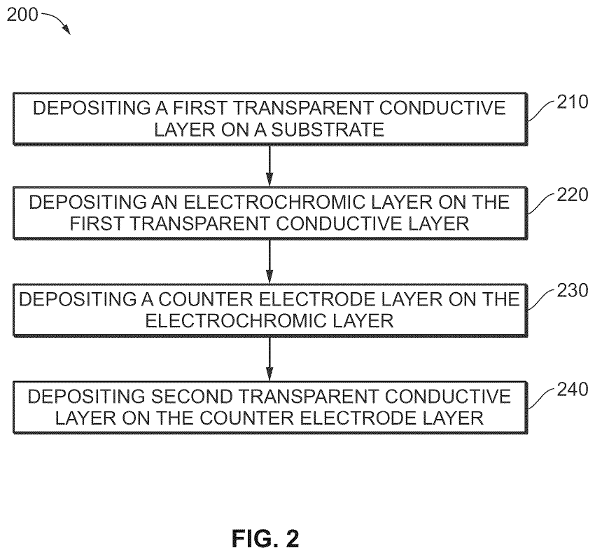

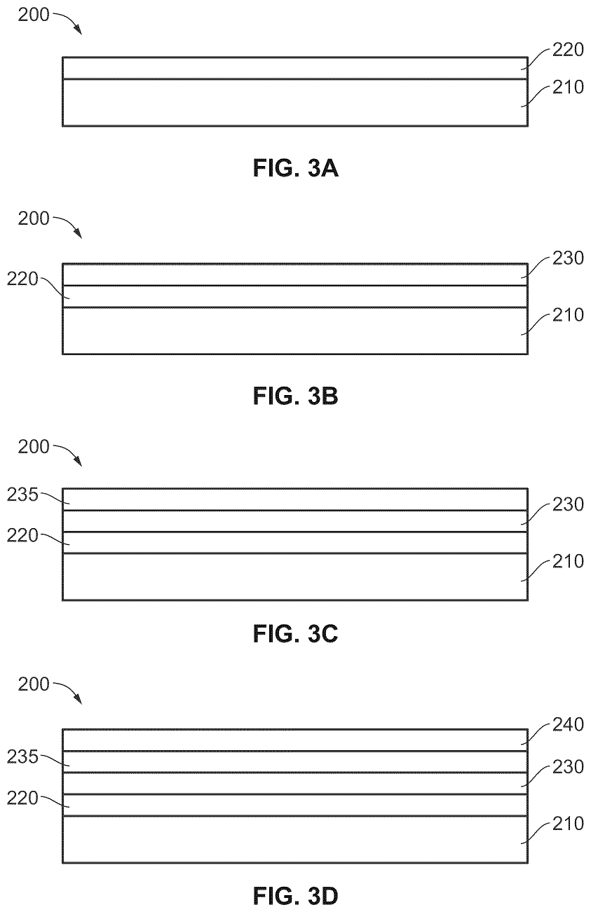

FIG. 2 is a flow chart depicting a process 200 for forming an electrochromic device in accordance with one embodiment of the current disclosure. FIGS. 3A-3E are a schematic cross-section of an electrochromic device 200 at various stages of manufacturing in accordance with one embodiment of the present disclosure. The electrochromic device 200 can be the same as the electrochromic devices 100 described above. The process can include providing a substrate 210. The substrate 210 can be similar to the substrate 110 described above. At operation 215, a first transparent conductive layer 220 can be deposited on the substrate 210, as seen in FIG. 3A. The first transparent conductive layer 220 can be similar to the first transparent conductive layer 120 described above. In one embodiment, the deposition of the first transparent conductive layer 220 can be carried out by sputter deposition at a power of between 5 kW and 20 kW, at a temperature between 200° C. and 400° C., in a sputter gas including oxygen and argon at a rate between 0.1 m/min and 0.5 m/min. In one embodiment, the sputter gas includes between 40% and 80% oxygen and between 20% and 60% argon. In one embodiment, the sputter gas includes 50% oxygen and 50% argon. In one embodiment, the temperature of sputter deposition can be between 250° C. and 350° C. In one embodiment, the first transparent conductive layer 220 can be carried out by sputter deposition at a power of between 10 kW and 15 kW.

In one embodiment, an intermediate layer can be deposited between the substrate 210 and the second transparent conductive layer 220. In one embodiment, the intermediate layer can include an insulating layer such as an antireflective layer. The antireflective layer can include a silicon oxide, niobium oxide, or any combination thereof. In a particular embodiment, the intermediate layers can be an antireflective layer that can be used to help reduce reflection. The antireflective layer may have an index of refraction between the underlying layers (refractive index of the underlying layers can be approximately 2.0) and clean, dry air or an inert gas, such as Ar or N2 (many gases have refractive indices of approximately 1.0). In one embodiment, the antireflective layer may have a refractive index in a range of 1.4 to 1.6. The antireflective layer can include an insulating material having a suitable refractive index. In a particular embodiment, the antireflective layer may include silica. The thickness of the antireflective layer can be selected to be thin and provide the sufficient antireflective properties. The thickness for the antireflective layer can depend at least in part on the refractive index of the electrochromic layer 230 and counter electrode layer 240. The thickness of the intermediate layer can be in a range of 20 nm to 100 nm.

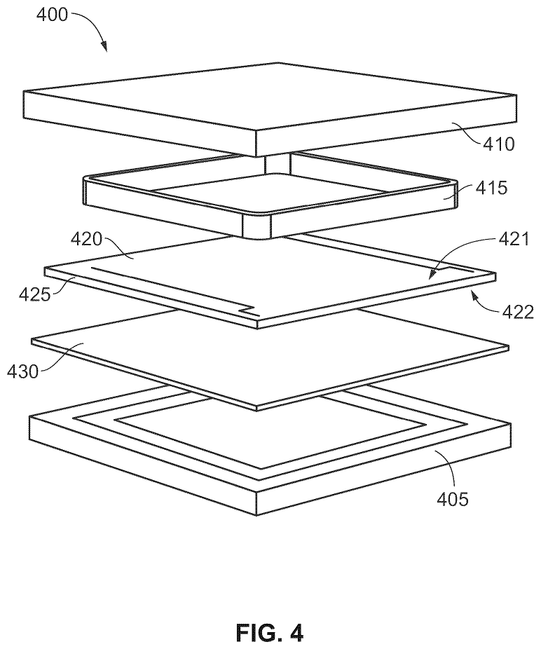

At operation 225 and as seen in FIG. 3B, an electrochromic layer 230 may be deposited on the first transparent conductive layer 220. The electrochromic layer 230 can be similar to the electrochromic layer 130 described above. In one embodiment, the deposition of the electrochromic layer 230 may be carried out by sputter deposition of tungsten, at a temperature between 23° C. and 350° C., in a sputter gas including oxygen and argon. In one embodiment, the average temperature of deposition can be between 100° C. and 300° C., such as an average temperature of between 150° C. and 285° C., or an average temperature of between 200° C. and 280° C. In one embodiment, the sputter gas includes between 40% and 80% oxygen and between 20% and 60% argon. In one embodiment, the sputter gas includes 50% oxygen and 50% argon. In one embodiment, the temperature of sputter deposition is between 100° C. and 250° C. In one embodiment, the temperature of sputter deposition is less than 210° C. An additional deposition of tungsten may be sputter deposited in a sputter gas that includes 100% oxygen. Surprisingly, as the electrochromic layer 230 is deposited at a temperature less than 210° C., the color of less than 3b* in a tint state can be seen in the electrochromic device 200. In one embodiment, as the electrochromic layer 230 is deposited at a temperature closer to the temperature of the counter electrode layer 240, the electrochromic device 200 can have a color of less than 2b*, as seen in FIG. 5. FIG. 5 is a schematic graph of the transmitted color as the electrochromic device switches from a clear state (high b*) to a tint state (low negative b*). In one embodiment, the electrochromic device can have a b* of between −2 and −4.5 in its darkest hold tint state, where the darkest hold tint state is about less than 3% luminous transmission. In one embodiment, the darkest tint state can be less than 5% luminous transmission, such as 4% luminous transmission, such as 3% luminous transmission, or 2% luminous transmission, or 1% luminous transmission. In another embodiment, as the electrochromic layer 230 is deposited at a temperature less than 210° C., the color of less than 0b* in a tint state can be seen in the electrochromic device 200.

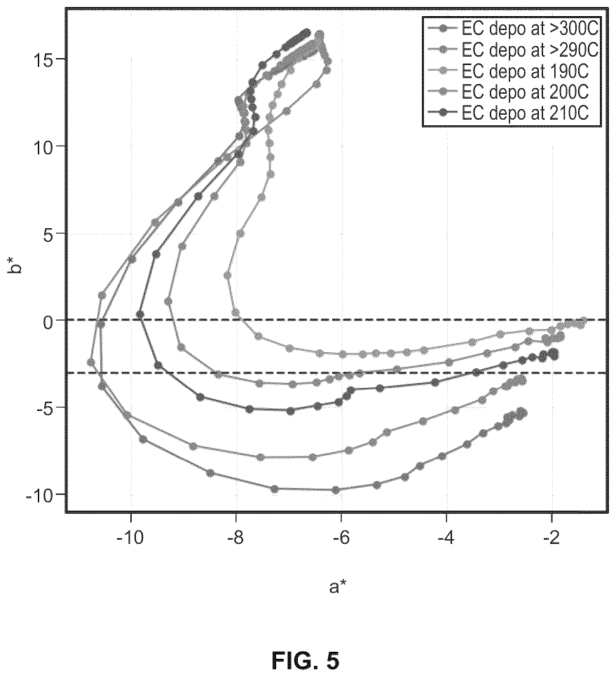

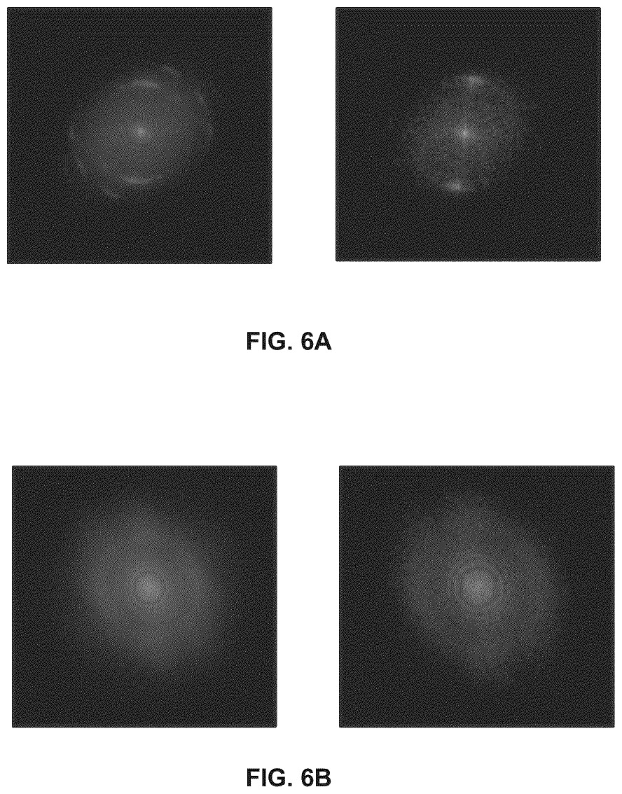

While not wishing to be bound by any one theory, the lower temperature deposition may affect the crystallinity of the tungsten in the electrochromic layer, thus affecting the color of the electrochromic device as a whole. As can be seen with the TEM diffraction graphs in FIGS. 6A and 6B, the crystallinity of the electrochromic layer 230 changes as the deposition temperature changes. In FIG. 6A, the electrochromic layer was deposited at an average temperature of about 290° C. As can be seen in FIG. 6A, the electrochromic layer has a partially crystalline structure. The electrochromic layer of FIG. 6B was deposited at an average temperature of less than 280° C. As can be seen in FIG. 6B, the electrochromic layer has an amorphous structure.

Additionally, as the temperature varies so too does the measurable XRD signals in the clear state. Specifically, two peaks are discernable in XRD spectra analysis for the clear state when the electrochromic layer is deposited as outlined above at a temperature below 290° C.

The peaks can then be analyzed, as seen in Table 1, to determine the crystallite size. In one embodiment, the Debye calculated crystallite size of the tungsten oxide peak of the electrochromic layer measured in an essentially clear state at 23.2 deg (left peak) can be between 10 nm and 40 nm, such as between 13 nm and 30 nm, or such as between 15 nm and 25 nm. In another embodiment, the Debye calculated crystallite size of the tungsten oxide peak of the electrochromic layer measured in an essentially clear state at 23.8 deg (right peak) can be between 3 nm and 8 nm, such as between 4 nm and 6 nm. In another embodiment, the ratio of the Debye calculated crystallite sizes of the tungsten peak of the electrochromic layer in a clear state at 23.2 deg and 23.8 deg can be between 0.05 and 0.8, such as between 0.1 and 0.5, or such as between 0.15 and 0.3. In another embodiment, the tungsten peak intensities of the electrochromic layer measured in a clear state at 23.2 deg and 23.8 deg can be between 0.05 and 0.40, such as between 0.02 and 0.3, or such as between 0.03 and 0.2, or such as between 0.05 and 0.1.

However, as the temperature of the deposition of the electrochromic layer 230 has a beneficial effect on color neutrality, there is a detrimental effect on the switching speed of the electrochromic device. In order to address the switching speed of the device, the inventors have unexpectedly determined that a combination of lower temperature deposition for the electrochromic layer, a decrease in the thickness of the ion conducting layer, and an increase in the thickness of the counter electrode layer increases the switching speed while maintaining color neutrality, as will be discussed in more detail below.

At operation 235 and as seen in FIG. 2C, an ion conducting layer 226 may be deposited on the electrochromic layer 230. The ion conducting layer 226 can be similar to the ion conducting layer 126 described above. The ion conducting layer 226 may be deposited at a temperature between 23° C. and 500° C. in a sputter gas including oxygen and argon. In one embodiment, the temperature of sputter deposition is between 150° C. and 450° C. In another embodiment, the deposition of the metal layer 435 may be carried out in a sputter gas including between 0% and 5% oxygen and between 100% to 95% argon. In one embodiment, the ion conducting layer 235 may be deposited to form a layer with a thickness between 1 nm and 20 nm. In one embodiment, the metal layer may have a thickness of no greater than 10 nm, such as no greater than 9 nm, no greater than 8 nm, no greater than 7 nm, or no greater than 6 nm.

At operation 245, a counter electrode layer 240 may be deposited on the ion conducting layer 226. In one embodiment, the counter electrode 240 can be similar to the counter electrode layer 140 described above. In one embodiment, the deposition of the counter electrode layer 240 may be carried out by sputter deposition of tungsten, nickel, and lithium, at a temperature between 20° C. and 50° C., in a sputter gas including oxygen and argon. In one embodiment, the sputter gas includes between 60% and 80% oxygen and between 20% and 40% argon. In one embodiment, the temperature of sputter deposition is between 22° C. and 32° C. In one embodiment, the counter electrode layer 240 can be deposited to a thickness of greater than 250 nm, such as greater than 260 nm, or greater than 270 nm, or greater than 280 nm, or greater than 290 nm, or greater than 300 nm. In one embodiment, the counter electrode layer 240 can be deposited to a thickness of no greater than 600 nm. In another embodiment, the counter electrode layer 240 can be deposited to a thickness of greater than 260 nm and no greater than 600 nm. Unexpectedly, the synergistic effect of an increased thickness of the counter electrode layer 240, a decreased thickness of the ion conducting layer 226, and the lower deposition temperature for the electrochromic layer increases the switching speed while maintaining color neutrality for the electrochromic device 200.

At operation 255 and as seen in FIG. 3E, a second transparent conductive layer 250 may be deposited on the counter electrode layer 240. The second transparent conductive layer 250 can be similar to the second transparent conductive layer 150 described above. In one embodiment, the deposition of the second transparent conductive layer 250 may be carried out by sputter deposition at a power of between 5 kW and 20 kW, at a temperature between 20° C. and 50° C., in a sputter gas including oxygen and argon. In one embodiment, the sputter gas includes between 1% and 10% oxygen and between 90% and 99% argon. In one embodiment, the sputter gas includes 8% oxygen and 92% argon. In one embodiment, the temperature of sputter deposition is between 22° C. and 32° C. In one embodiment, the substrate 210, first transparent conductive layer 220, the electrochromic layer 230, the counter electrode layer 240, and the second transparent conductive layer 250 may be heated at a temperature between 300° C. and 500° C. for between 2 min and 10 min. In one embodiment, additional layers may be deposited on the second transparent conductive layer 250.

After depositing the second transparent conductive layer 250, the stack including the substrate 210, the first transparent conductive layer 220, the cathodic electrochemical layer 230, the ion conducting layer 226, the anodic electrochemical layer 240, and the second transparent conductive layer 250 can be heated at a temperature between 300° C. and 700° C. In one embodiment, the stack is heated at a temperature between 400° C. and 450° C. In one embodiment, the stack is heated for a period between 1 min. and 30 mins. In one embodiment, the stack is heated for a period between 3 mins. and 5 mins. In one embodiment, the stack is heated by laser anneal. In another embodiment, the stack is heated after breaking vacuum.

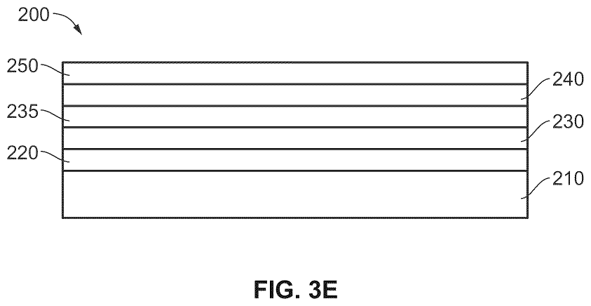

Any of the electrochemical devices can be subsequently processed as a part of an insulated glass unit. FIG. 4 is a schematic illustration of an insulated glazing unit 400 according the embodiment of the current disclosure. The insulated glass unit 400 can include a first panel 405, an electrochemical device 420 coupled to the first panel, a second panel 410, and a spacer 415 between the first panel 405 and second panel 410. The first panel 405 can be a glass panel, a sapphire panel, an aluminum oxynitride panel, or a spinel panel. In another embodiment, the first panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The first panel 405 may or may not be flexible. In a particular embodiment, the first panel 405 can be float glass or a borosilicate glass and have a thickness in a range of 2 mm to 20 mm thick. The first panel 405 can be a heat-treated, heat-strengthened, or tempered panel. In one embodiment, the electrochemical device 420 is coupled to first panel 405. In another embodiment, the electrochemical device 420 is on a substrate 425 and the substrate 425 is coupled to the first panel 405. In one embodiment, a lamination interlayer 430 may be disposed between the first panel 405 and the electrochemical device 420. In one embodiment, the lamination interlayer 430 may be disposed between the first panel 405 and the substrate 425 containing the electrochemical device 420. The electrochemical device 420 may be on a first side 421 of the substrate 425 and the lamination interlayer 430 may be coupled to a second side 422 of the substrate. The first side 421 may be parallel to and opposite from the second side 422.

The second panel 410 can be a glass panel, a sapphire panel, an aluminum oxynitride panel, or a spinel panel. In another embodiment, the second panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The second panel may or may not be flexible. In a particular embodiment, the second panel 410 can be float glass or a borosilicate glass and have a thickness in a range of 5 mm to 30 mm thick. The second panel 410 can be a heat-treated, heat-strengthened, or tempered panel. In one embodiment, the spacer 415 can be between the first panel 405 and the second panel 410. In another embodiment, the spacer 415 is between the substrate 425 and the second panel 410. In yet another embodiment, the spacer 415 is between the electrochemical device 420 and the second panel 410.

In another embodiment, the insulated glass unit 400 can further include additional layers. The insulated glass unit 400 can include the first panel, the electrochemical device 420 coupled to the first panel 405, the second panel 410, the spacer 415 between the first panel 405 and second panel 410, a third panel, and a second spacer between the first panel 405 and the second panel 410. In one embodiment, the electrochemical device may be on a substrate. The substrate may be coupled to the first panel using a lamination interlayer. A first spacer may be between the substrate and the third panel. In one embodiment, the substrate is coupled to the first panel on one side and spaced apart from the third panel on the other side. In other words, the first spacer may be between the electrochemical device and the third panel. A second spacer may be between the third panel and the second panel. In such an embodiment, the third panel is between the first spacer and second spacer. In other words, the third panel is coupled to the first spacer on a first side and coupled to the second spacer on a second side opposite the first side.

The embodiments described above and illustrated in the figures are not limited to rectangular shaped devices. Rather, the descriptions and figures are meant only to depict cross-sectional views of a device and are not meant to limit the shape of such a device in any manner. For example, the device may be formed in shapes other than rectangles (e.g., triangles, circles, arcuate structures, etc.). For further example, the device may be shaped three-dimensionally (e.g., convex, concave, etc.).

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. An electrochromic device is disclosed. The electrochromic device can include a first transparent conductive layer, a second transparent conductive layer, an electrochromic layer between the first transparent conductive layer and the second transparent conductive layer, and a counter electrode layer between the first transparent conductive layer and the second transparent conductive layer having a thickness of greater than 300 nm. The electrochromic device can have a switching speed parameter of not greater than 0.68 s/mm, such as 0.6 s/mm, no greater than 0.5 s/mm, or no greater than 0.4 s/mm at 23° C. and a color of less than 3b* in a tint state.

Embodiment 2. The electrochromic device of embodiment 1, where the electrochromic layer has an amorphous structure.

Embodiment 3. The electrochromic device of embodiment 1, where the Debye calculated crystallite size of the electrochromic layer in the clear state at 23.8 deg (right peak) is greater than 0 nm and less than 9 nm.

Embodiment 4. The electrochromic device of embodiment 1, where the Debye calculated crystallite size of the electrochromic layer in the clear state at 23.2 deg (left peak) is greater than 10 nm and less than 40 nm.

Embodiment 5. The electrochromic device of embodiment 1, further can include a substrate, where the first transparent conductive layer is on the substrate.

Embodiment 6. The electrochromic device of embodiment 5, where the substrate can include glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

Embodiment 7. The electrochromic device of embodiment 1, further can include an ion conducting layer between the electrochromic layer and the counter electrode layer.

Embodiment 8. The electrochromic device of embodiment 7, where the ion conducting layer can include lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

Embodiment 9. The electrochromic device of embodiment 7, where the ion conducting layer has a thickness of less than 10 nm, such as less than 9 nm, or less than 8 nm, or less than 7 nm.

Embodiment 10. The electrochromic device of embodiment 1, where the electrochromic material can include WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 11. The electrochromic device of embodiment 1, where the first transparent conductive layer can include indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 12. The electrochromic device of embodiment 1, where the second transparent conductive layer can include indium oxide, indium tin oxide, doped indium oxide, tin oxide, doped tin oxide, zinc oxide, doped zinc oxide, ruthenium oxide, doped ruthenium oxide and any combination thereof.

Embodiment 13. The electrochromic device of embodiment 1, where the counter electrode layer can include a an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Embodiment 14. The electrochromic device of embodiment 1, where the counter electrode layer has a thickness of greater than 320 nm and less than 600 nm.

Embodiment 15. The electrochromic device of embodiment 1, where the second transparent conductive layer can include a thickness between 10 nm to about 600 nm.

Embodiment 16. The electrochromic device of embodiment 1, where the first transparent conductive layer can include a thickness between 10 nm to about 600 nm.

Embodiment 17. The electrochromic device of embodiment 1, where the electrochromic layer can include a thickness between 40 nm to about 600 nm.

Embodiment 18. The electrochromic device of embodiment 2, where the substrate has a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm.

Embodiment 19. The electrochromic device of embodiment 2, further can include a first panel coupled to the substrate and a lamination layer between the substrate and the first panel.

Embodiment 20. The electrochromic device of embodiment 19, further can include a second panel coupled to the first panel.

Embodiment 21. The electrochromic device of embodiment 20, further can include a spacer frame disposed between the first panel and the second panel.

Embodiment 22. The electrochromic device of embodiment 21, further can include a lamination interlayer between the first panel and the electrochemical device.

Embodiment 23. A method of forming an electrochromic device can include: depositing a first transparent conductive layer on a substrate; depositing an electrochromic layer on the first conductive layer at a temperature of less than 220° C.; depositing a counter electrode layer on the electrochromic layer, where the counter electrode layer can include a thickness of greater than 300 nm; and depositing a second transparent conductive layer on the counter electrode layer.

Embodiment 24. The method of embodiment 23, further can include depositing an ion conducting layer on the electrochromic layer.

Embodiment 25. The method of embodiment 24, further can include heating the substrate, first transparent conductive layer, cathodic electrochemical layer, and ion conducting layer at a temperature between 23° C. and 500° C. before depositing the counter electrode layer.

Embodiment 26. The method of embodiment 23, where the electrochromic material can include WO₃, V₂O₅, MoO₃, Nb₂O₅, TiO₂, CuO, Ni₂O₃, Ir₂O₃, Cr₂O₃, Co₂O₃, Mn₂O₃, mixed oxides (e.g., W—Mo oxide, W—V oxide), lithium, aluminum, zirconium, phosphorus, boron, a borate with or without lithium, a tantalum oxide with or without lithium, a lanthanide-based material with or without lithium, another lithium-based ceramic material, or any combination thereof.

Embodiment 27. The method of embodiment 23, where depositing the electrochromic layer on the first conductive layer is carried out by sputter deposition of tungsten in a sputter gas can include between 40% and 80% oxygen and between 20% to 60% argon.

Embodiment 28. The method of embodiment 24, where depositing the ion conducting layer is carried out in a sputter gas can include between 0% and 5% oxygen and between 100% to 95% argon at a temperature between 23° C. and 500° C.

Embodiment 29. The method of embodiment 23, where ion conductor has a thickness of no greater than 20 nm, such as 10 nm, no greater than 9 nm, no greater than 8 nm, no greater than 7 nm, or no greater than 6 nm.

Embodiment 30. The method of embodiment 23, where the electrochromic device can include a switching speed parameter of not greater than 0.58 s/mm at 23° C.

Embodiment 31. The method of embodiment 23, where the electrochromic device can include a switching speed parameter of not greater than 1.1 s/mm at −20° C.

Embodiment 32. The method of embodiment 23, where the substrate can include glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

Embodiment 33. The method of embodiment 32, where the substrate has a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm.

Embodiment 34. The method of embodiment 23, where the first transparent conductive layer can include indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 35. The method of embodiment 23, where the counter electrode layer can include a an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni2O3, or combination of the two), and Li, nitrogen, Na, H, or another ion, any halogen, or any combination thereof.

Embodiment 36. The method of embodiment 23, where the second transparent conductive layer can include indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

### Examples

An example is provided to demonstrate the performance of an electrochemical device with an electrochromic layer deposited as a temperature of less than 220° C. as compared to other electrochemical devices with an electrochromic layer deposited at a temperature of more than 220° C. For the various examples below, sample 1 (S1) was formed in accordance to the various embodiments described above. Comparative sample, Sample 2 (S2) is understood to be an embodiment with an electrochromic layer deposited at a temperature of more than 220° C. with a counter electrode layer having a thickness of less than 300 nm. Sample 3 (S3) is understood to be an embodiment with an electrochromic layer deposited at a temperature of less than 220° C. and with a counter electrode layer having a thickness of less than 300 nm.

FIG. 5 is a schematic graph of the tinting states of the various samples S1, S2. The y-axis is the tinted percentage and the x-axis is the temperature of the deposition of the electrochromic layer. Below is Table 2 with the data from the graph of FIG. 5.

| | Clear State | Dark State | Switching | Counter electrode |
|---|---|---|---|---|
| | Color | Color | speed | thickness |
| Sample 1 | 14-16b* | −0.5b* | 1.16 | >300 nm |
| (S1) | | | | |
| Sample 2 | 14-16b* | −8b* | 0.3 | <300 nm |
| (S2) | | | | |
| Sample 3 | 14-16b* | −2b* | 1.16 | <300 nm |
| (S3) | | | | |

S1 has an average switching speed of 0.89 sec/mm, with the lowest switching speed of 0.76 sec/mm. S2 has an average switching speed of 0.61 sec/mm, with the highest switching speed of 0.73 sec/mm. S3 has an average switching speed of 0.73 sec/mm, with the lowest switching speed of 0.75 sec/mm. Switching speed changes with temperature. Below is Table 3 with data of switching speed s/mm of S1 and S2 with varied IC thicknesses.

| | Mean | Low | High |
|---|---|---|---|
| Sample 2 (S2), | 0.30 | 0.26 | 0.35 |
| normal IC thickness | | | |
| Sample 1 (S1a) | 1.16 | 0.83 | 1.58 |
| with normal IC | | | |
| thickness | | | |
| Sample 1 (S1b), | 0.36 | 0.29 | 0.42 |
| with thinner IC | | | |

S1a with a normal ion conducting layer (IC) thickness can have an average switching speed of 1.16 s/mm. S1a and S2 with a normal ion conducting layer has an IC thickness of 9 nm. S1b with a thinner IC has an IC thickness of 6 nm. S2 has an average switching speed of 0.30 s/mm, with the lowest switching speed of 0.26 s/mm. S1 with a thinner IC can have a switching speed parameter of not greater than 0.42 s/mm, such as 0.36 s/mm, no greater than 0.3 s/mm, or no greater than 0.29 s/mm at −20° C. The thickness of the thinner IC sample can be no greater than 6 nm. The thickness of the normal IC is between 9 nm and 20 nm.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An electrochromic device, comprising:
a first transparent conductive layer;
a second transparent conductive layer;
an electrochromic layer between the first transparent conductive layer and the second transparent conductive layer;
a counter electrode layer between the first transparent conductive layer and the second transparent conductive layer having a thickness of greater than 300 nm;
a switching speed parameter of not greater than 0.68 s/mm, such as 0.6 s/mm, no greater than 0.5 s/mm, or no greater than 0.4 s/mm at 23° C.;
and a color of less than 3b* in a tint state.

2. The electrochromic device of claim 1, wherein the electrochromic layer has an amorphous structure.

3. The electrochromic device of claim 1, wherein the Debye calculated crystallite size of the electrochromic layer in the clear state at 23.8 deg (right peak) is greater than 0 nm and less than 9 nm.

4. The electrochromic device of claim 1, wherein the Debye calculated crystallite size of the electrochromic layer in the clear state at 23.2 deg (left peak) is greater than 10 nm and less than 40 nm.

5. The electrochromic device of claim 1, further comprising a substrate, wherein the first transparent conductive layer is on the substrate.

6. The electrochromic device of claim 5, wherein the substrate comprises glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

7. The electrochromic device of claim 1, further comprising an ion conducting layer between the electrochromic layer and the counter electrode layer.

8. The electrochromic device of claim 7, wherein the ion conducting layer comprises lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

9. The electrochromic device of claim 7, wherein the ion conducting layer has a thickness of less than 10 nm, such as less than 9 nm, or less than 8 nm, or less than 7 nm.

10. The electrochromic device of claim 1, wherein the electrochromic material comprises WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

11. The electrochromic device of claim 1, wherein the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

12. The electrochromic device of claim 1, wherein the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

13. The electrochromic device of claim 1, wherein the counter electrode layer comprises a an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

14. The electrochromic device of claim 1, wherein the counter electrode layer has a thickness of greater than 320 nm and less than 600 nm.

15. The electrochromic device of claim 1, wherein the second transparent conductive layer comprises a thickness between 10 nm to about 600 nm.

16. The electrochromic device of claim 1, wherein the first transparent conductive layer comprises a thickness between 10 nm to about 600 nm.

17. The electrochromic device of claim 1, wherein the electrochromic layer comprises a thickness between 40 nm to about 600 nm.

18. The electrochromic device of claim 2, further comprising a first panel coupled to the substrate and a lamination layer between the substrate and the first panel.

19. A method of forming an electrochromic device comprising:
depositing a first transparent conductive layer on a substrate;
depositing an electrochromic layer on the first conductive layer at a temperature of less than 220° C.;
depositing a counter electrode layer on the electrochromic layer, wherein the counter electrode layer comprises a thickness of greater than 300 nm; and
depositing a second transparent conductive layer on the counter electrode layer.

20. The method of claim 19, further comprising depositing an ion conducting layer on the electrochromic layer.
